(19) United States
(12) Patent Application Publication
(10) Pub. No.: US 2020/0293182 A1
(43) Pub. Date: Sep. 17, 2020

(54) INFORMATION PROCESSING APPARATUS AND NON-TRANSITORY COMPUTER READABLE MEDIUM

(71) Applicant: FUJI XEROX CO., LTD., Tokyo (JP)

(72) Inventor: Naoki OKAMOTO, Kanagawa (JP)

(73) Assignee: FUJI XEROX CO., LTD., Tokyo (JP)

(21) Appl. No.: 16/545,075

(22) Filed: Aug. 20, 2019

(30) Foreign Application Priority Data
Mar. 13, 2019 (JP) 2019-046072

(51) Int. Cl. G06F 3/0484; G06F 3/0486

(52) U.S. Cl. CPC G06F 3/04845; G06F 3/0486

(57) ABSTRACT

An information processing apparatus includes a first display controller and a second display controller. The first display controller is configured to perform control to display plural pieces of data acquired from plural storage regions on one common screen, and to display a storage region display that shows the storage region in which each of the plural pieces of data is stored, on the common screen. The second display controller is configured to perform control to change the storage region display on the common screen in accordance with an operation with respect to data displayed on the common screen.

### CROSS-REFERENCE TO RELATED APPLICATIONS

This application is based on and claims priority under 35 USC 119 from Japanese Patent Application No. 2019-046072 filed Mar. 13, 2019.

### BACKGROUND

### (i) Technical Field

The present disclosure relates to an information processing apparatus and a non-transitory computer readable medium.

### (ii) Related Art

U.S. Pat. No. 5,444,776 describes a technology in which plural files to be recycled by a computer are acquired, each of alternative images that represent the plural files in a workspace is disposed as described in the drawings in accordance with a distance determined based on the similarity between the plural files, at least one stack including at least a part of plural files is determined, files that are close to at least one stack in the workspace are determined, and the files determined to be close are used to form a close portion.

JP-A-2008-236468 describes a technology in which, when a thumbnail image A that represents an image file having date and time information indicating the same shooting date as a reference shooting date and a thumbnail image B that represents an image file having date and time information indicating shooting date different from the reference shooting date are disposed to be adjacent to each other on a display screen, a list in which a dividing line is added between the thumbnail image A and the thumbnail image B is displayed and output on an output device.

JP-T-2006-521592 describes a technology in which items from plural physical positions are displayed such that all items look like objects from one position, a file system uses a virtual folder, the virtual folder is not a basic structure of an actual physical file system on a disk, and ordinary files and folders are exposed to users in various views based on the metadata.

In a case where plural pieces of data stored in plural storage regions are displayed on one common screen to enable data operation, the user cannot smoothly perform a desired operation when it is not possible to visually recognize in which storage region each piece of data is stored on the common screen.

### SUMMARY

Aspects of non-limiting embodiments of the present disclosure relate to provide a technology that, when data stored in plural storage regions are displayed and operated on one common screen, allows a user to grasp which storage region each piece of data is stored in.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing apparatus including: a first display controller configured to perform control to display plural pieces of data acquired from plural storage regions on one common screen, and to display a storage region display that shows the storage region in which each of the plural pieces of data is stored, on the common screen; and a second display controller configured to perform control to change the storage region display on the common screen in accordance with an operation with respect to data displayed on the common screen.

### BRIEF DESCRIPTION OF THE DRAWINGS

Exemplary embodiment(s) of the present disclosure will be described in detail based on the following figures, wherein:

FIG. 1 is a configuration view of an exemplary embodiment;

FIG. 2 is a process flowchart of the exemplary embodiment;

FIG. 3 is a partial detailed flowchart of FIG. 2;

FIG. 4 is an explanatory view (1) of a common screen of the exemplary embodiment;

FIG. 5 is an explanatory view (2) of the common screen of the exemplary embodiment;

FIG. 6 is an explanatory view (3) of the common screen of the exemplary embodiment;

FIG. 7 is an explanatory view (4) of the common screen of the exemplary embodiment;

FIG. 8 is an explanatory view (5) of the common screen of the exemplary embodiment;

FIG. 9 is an explanatory view (6) of the common screen of the exemplary embodiment;

FIG. 10 is an explanatory view (7) of the common screen of the exemplary embodiment;

FIG. 11 is an explanatory view (8) of a common screen of the exemplary embodiment;

FIG. 12 is an explanatory view (9) of the common screen of the exemplary embodiment;

FIG. 13 is an explanatory view (10) of the common screen of the exemplary embodiment;

FIG. 14 is an explanatory view (11) of the common screen of the exemplary embodiment;

FIG. 15 is an explanatory view (12) of the common screen of the exemplary embodiment;

FIG. 16 is an explanatory view (13) of the common screen of the exemplary embodiment;

FIG. 17 is an explanatory view (14) of the common screen of the exemplary embodiment;

FIG. 18 is an explanatory view (15) of the common screen of the exemplary embodiment;

FIG. 19 is an explanatory view (16) of the common screen of the exemplary embodiment; and

FIG. 20 is an explanatory view (17) of the common screen of the exemplary embodiment.

### DETAILED DESCRIPTION

Hereinafter, an exemplary embodiment of the present disclosure will be described with reference to the drawings.

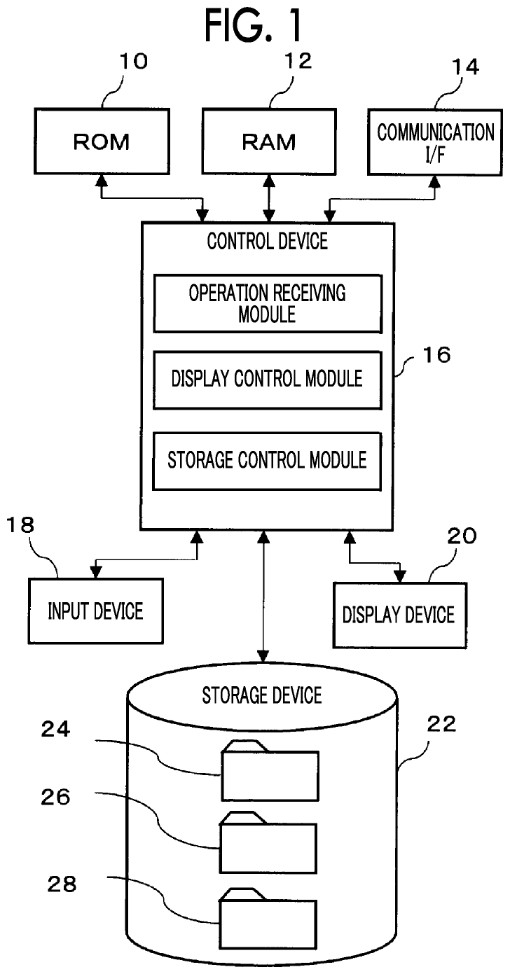

FIG. 1 illustrates the entire configuration view of an information processing apparatus in the exemplary embodiment. The information processing apparatus includes a ROM 10, a RAM 12, a communication interface (I/F) 14, a control device 16, an input device 18, a display device 20, and a storage device 22.

The control device 16 is configured with one or plural processors, retrieves a processing program stored in a program memory, such as the ROM 10, and executes various processing by executing the processing program using the RAM 12 as a working memory. Some of the functions of the control device 16 may be implemented not by software processing by program execution but by hardware processing. The hardware processing may be performed using a circuit, such as an ASIC or a field programmable gate array (FPGA). When the control device 16 receives a user operation via the input device 18, such as a mouse or a keyboard, the control device 16 retrieves a file, such as a document stored in the storage device 22, and displays the file on the display device 20. The storage device 22 is configured with a hard disk drive (HDD), a solid state drive (SSD), or the like, and includes plural repositories as plural storage regions. In the drawings, plural repositories are illustrated as plural folders 24, 26, and 28, and each folder stores files, such as one or plural documents.

The control device 16 includes an operation receiving module, a display control module, and a storage control module as functional modules in order to execute each process. Here, “module” refers to a logically separatable component such as software and hardware. The modules may correspond to functions in a one to one correspondence relationship. Alternatively, one module may be implemented by one program. Further alternatively, plural modules may be implemented by one program. In addition, plural modules may be executed by one processor or by plural processors in a dispersed or parallel environment. In processing by each module, target information is read and processed by a processor, such as the CPU, and then the processing result is output.

The operation receiving module receives a user operation input from the input device 18 and supplies the user operation to the display control module. The user operation is an instruction to display a file, such as a document stored in the plural folders 24, 26, and 28 of the storage device 22, an instruction to move a file, such as a document, an instruction to edit, an instruction to delete, or the like.

The display control module functions as a first display controller to a third display controller, and displays file information, such as documents stored in the folders 24, 26, and 28 in accordance with the received user operation. The display control module displays file information, such as documents stored in each of the folders 24, 26 and 28 on one common screen, and displays a storage region display that indicates in which folder each file, such as a document, is stored, on the common screen. Further, the common screen here is a display region that allows editing operations, such as file movement, for files stored in different folders (or different repositories) without depending on the stored folders. In addition, displaying the storage region display on the common screen may refer to displaying on the common screen such that the folder to which the file belongs can be identified.

The display form of the storage region display is any form, and any shape, pattern, or color or a combination thereof is used. The display forms can be changed from one another to identify the storage regions from one another. For example, file information of plural documents or the like stored in the same folder may be surrounded by closed curves of the same type, or colors of file information of plural documents or the like stored in the same folder may be standardized. The file information is, for example, a symbolic figure of a file, and specifically, an icon, a thumbnail or the like. The display control module displays the symbolic figures of the respective files on the common screen while maintaining a state where the respective files are stored in the folders 24, 26, and 28. In the following description, a closed curve that surrounds symbolic figures of files, such as documents stored in the same folder will be exemplified as the storage region display, and this will be referred to as the same group. The display control module moves and displays the symbolic figure of the file, such as the document, in accordance with the movement operation in a case where the symbolic figure of the file, such as the document displayed on the common screen, is moved and operated, and the storage region display is also changed in accordance with the movement of the symbolic figure. Specifically, the change in storage region display is, for example, the size change or deletion of the storage region display before and after the movement.

The storage control module functions as a controller, accesses the folders 24, 26, and 28 of the storage device 22 and controls the storage of files, such as actual documents, in the folders 24, 26, and 28. The storage control module does not move the storage region in which the file, such as the actual document, is stored when moving the symbolic figure of the file, such as the document, in accordance with the movement operation by the display control module, and moves the storage region in which the file, such as the actual document, is stored at a specific timing. In other words, the storage control module reflects the movement of the file, such as the actual document, in the storage region at a specific timing after the movement operation. Before the specific timing, the symbolic figure of the file, such as the document, moves in accordance with the movement operation on the common screen, but the file in the storage region is not moved, and in a case where the specific timing is reached and the display control module is reflected in the storage region, the movement of the symbolic figure of the file on the common screen matches the movement of the file between the storage regions. The specific timing is the timing when the operation is completed, and the completion timing is determined by an explicit operation from the user, for example. The storage control module does not move the storage region of the file, such as the actual document, until the explicit operation from the user is received by the operation receiving module, and moves the storage region of the file, such as the actual document, in a case where the explicit operation from the user is received.

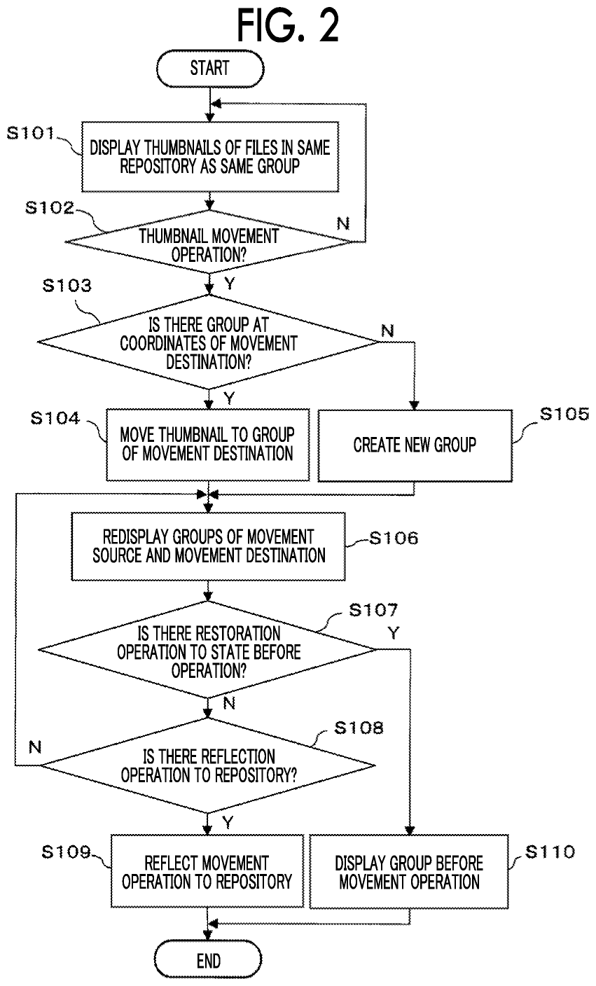

FIG. 2 illustrates a process flowchart of the exemplary embodiment. FIG. 2 is a process flowchart of the control device 16.

First, the control device 16 displays thumbnails of the files in the same repository as the same group on the common screen of the display device 20 (S101). More specifically, in a case where there are plural repositories, the files stored in each repository of the plural repositories are collectively displayed on one screen such that the repository to which the file belongs can be identified. Specifically, the same repository is the same folder and is displayed as the same group. In a case where the folders 24, 26, and 28 exist as plural folders as illustrated in FIG. 1, the files in the folder 24 are files in the same repository, the files in the folder 26 are files in another same repository, and the files in the folder 28 are files in yet another same repository. Therefore, the files in the folder 24, the files in the folder 26, and the files in the folder 28 are displayed as the same group. The thumbnails are reduced images as the symbolic figures of the files, and the sizes thereof do not matter. In a case where there are plural files in the same repository, the thumbnails that represent each file may further be reduced to have a smaller size than the standard size and displayed. The group display displays all the files in the same repository in a surrounding manner.

Next, the control device 16 determines whether a thumbnail movement operation has been received from the input device 18 (S102). In a case where the movement operation is not received (NO in S102), the process of S101 is maintained. In addition, the control device 16 holds the group on the common screen in the memory, such as the RAM 12, at a constant control timing. The held group can be used as a group before the movement operation which will be described later. In a case where the user operates the mouse or the like to move and operate one of the plural thumbnails displayed on the common screen (YES in S102), the control device 16 determines whether the group exists at the coordinates on the common screen of the movement destination of the thumbnails (S103). The determination is executed based on whether the coordinates of the thumbnail after the movement exist within the coordinate range that defines the group. Assuming that the coordinates on the common screen are defined by two-dimensional coordinates (x, y), when the coordinate range that defines a certain group is x1≤x≤x2 and y1≤y≤y2, in a case where the coordinates (xs, ys) of the thumbnail after the movement satisfy x1≤xs≤x2 and y1≤ys≤y2, it is determined that the group exists at the coordinates on the common screen of the movement destination of the thumbnail.

In a case where a group exists at the coordinates on the common screen of the movement destination of the thumbnail (YES in S103), the control device 16 moves the thumbnail to the inside of the group of the movement destination and displays the thumbnail (S104). On the other hand, in a case where a group does not exist at the coordinates on the common screen of the movement destination of the thumbnail (NO in S103), the control device 16 creates a new group that includes the coordinates on the common screen of the movement destination of the thumbnail (S105).

After moving the thumbnails to the group of the movement destination or creating a new group, the control device 16 changes and redisplays the groups of the movement source and movement destination (S106). Specifically, for the group of the movement source, the group is reduced and redisplayed so as to include all the thumbnails after the thumbnails have moved. In addition, for the group of the movement destination, the group is enlarged and redisplayed so as to include all the thumbnails including the newly added thumbnail. In a case of creating a new group, the group is not enlarged or reduced, but when the occupied area of the group of the coordinates before the movement is 0, it can be said that the part from 0 to a limited occupied area is enlarged and redisplayed.

After the group is redisplayed, the control device 16 determines whether a restoration operation to the state before the operation has been received from the input device 18 (S107). In a case where the restoration operation is received (YES in S107), the control device 16 retrieves the group before the movement operation held in the memory, such as the RAM 12, and displays the group on the common screen (S110). In addition, in a case where the restoration operation has not been received (NO in S107), it is further determined whether the reflection operation has been received from the input device 18 in the repository (S108). In a case where there is no restoration operation to the state before the operation and there is no reflection operation in the repository (NO in both S107 and S108), the processing after S106 is repeated. In a case where the reflection operation in the repository is received from the input device 18 (YES in S108), the control device 16 reflects the thumbnail movement operation in the repository (S109). In other words, although the control device 16 moves the thumbnail on the common screen of the display device 20 and changes the group in the processing of S104, S105, and S106, the files, such as the document stored in the folders 24, 26, and 28 are maintained as it is, and in a case where the explicit operation of “reflect in repository” from the user is received, the control device 16 moves the files, such as the documents stored in the folders 24, 26, and 28 so as to match the display of the thumbnail and the group on the common screen of the display device 20.

Here, although it is also possible to move the actual file between the folders each time the thumbnail of the file is moved, since communication processing between the control device 16 and the storage device 22 occurs, it takes a corresponding amount of time. Meanwhile, the number of times of communication processing (the number of times of access to the storage device 22) between the control device 16 and the storage device 22 is reduced by moving the actual file between folders at a specific timing after the thumbnail movement operation.

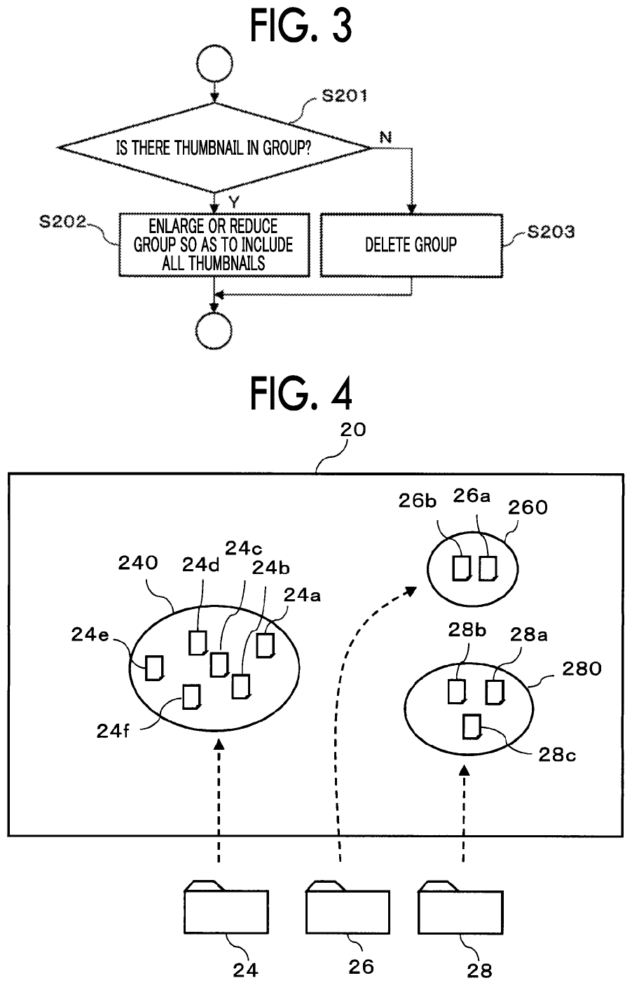

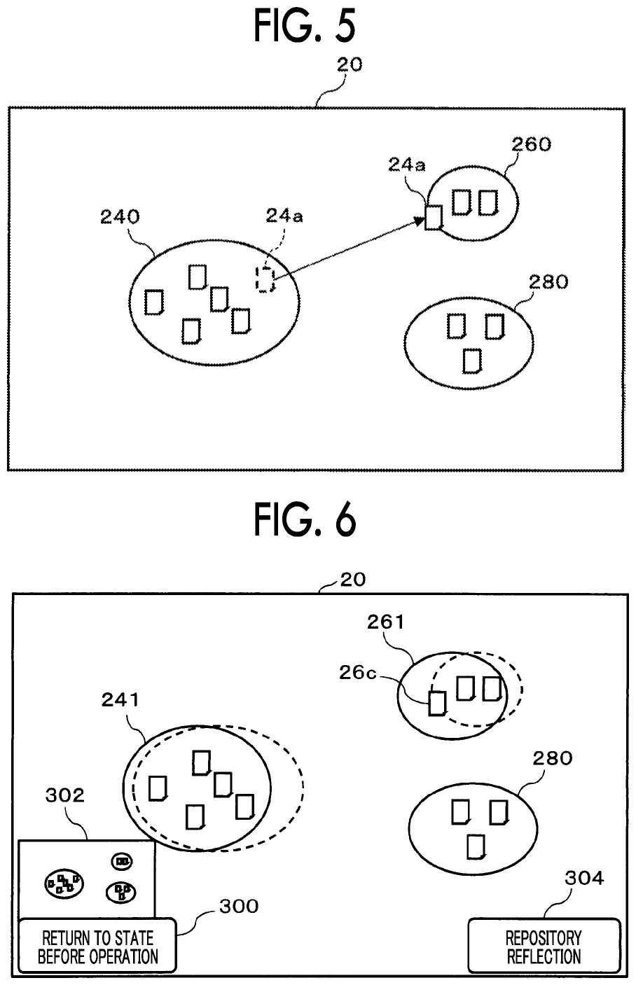

FIG. 3 illustrates a detailed flowchart of S106 in FIG. 2.

The control device 16 determines whether there is a thumbnail for the groups of the movement source and movement destination of the thumbnail (S201).

In a case where there is a thumbnail (YES in S201), the group is enlarged or reduced and redisplayed so as to include all the thumbnails (S202). In other words, since the number of thumbnails decreases in the group of the movement source, the group is reduced and redisplayed, and since the number of thumbnails increases in the group of movement destination, the group is enlarged and redisplayed. When redisplaying the group, the shapes, colors, patterns, and the like of closed curves of the group before enlargement and reduction and the group after enlargement and reduction may be changed. The group before enlargement and reduction is displayed in gray and the group after enlargement and reduction is displayed in black, the group before enlargement and reduction is displayed in broken line, and the group after enlargement and reduction is displayed in solid line. The change between the group before enlargement and reduction and the group after enlargement and reduction may be displayed by animation.

In a case where there is no thumbnail (NO in S201), the group is deleted from the display (S203). When deleting the group, the group before deletion may be faded out and deleted.

Next, the common screen displayed on the display device 20 in the present exemplary embodiment will be specifically described.

FIG. 4 illustrates an example of a common screen displayed on the display device 20. Thumbnails of the file group stored in the folder 24, the file group stored in the folder 26, and the file group stored in the folder 28 are displayed as symbolic figures on one screen, and the group is displayed surrounded by a closed curve as a storage region display for each folder.

The file groups stored in the folder 24 are displayed as thumbnails 24a to 24f, and a group 240 is displayed so as to include the thumbnails 24a to 24f.

In addition, the file groups stored in the folder 26 are displayed as the thumbnails 26a and 26b, and a group 260 is displayed so as to include the thumbnails 26a and 26b.

Furthermore, the file groups stored in the folder 28 are displayed as thumbnails 28a to 28c, and a group 280 is displayed so as to include the thumbnails 28a to 28c.

All of the groups 240, 260, and 280 are displayed in an elliptical shape, but may be in a circular shape or the like. In addition, the display form of the groups 240, 260, and 280, for example, the shape may be different for each group. For example, the group 240 may be elliptical, the group 260 may be circular, and the group 280 may be rectangular. The colors of the groups 240, 260, and 280 may be different for each group.

The groups 240, 260, and 280 are displayed at different coordinates on the common screen. Accordingly, the user can easily visually recognize that the thumbnails 24a to 24f, the thumbnails 26a and 26b, and the thumbnails 28a to 28c are stored in different folders, that is, different repositories.

FIG. 5 illustrates how the user moves the thumbnail by operating the input device 18, such as a mouse. The thumbnail 24a in the group 240 is moved to the region where the group 260 exists. The control device 16 detects the movement of the thumbnail 24a, and compares the coordinates of the movement destination with the region coordinates of the group 260 to determine that the group 260 exists at the coordinates of the movement destination.

FIG. 6 illustrates a redisplay screen of the group 240 which is the group of the movement source of the thumbnail 24a and the group 260 which is the group of the movement destination of the thumbnails 24a. Since the number of thumbnails of the group 240 of the movement source is reduced by the amount of movement of the thumbnail 24a, the group 240 is reduced and displayed as a group 241. On the other hand, since the number of thumbnails of the group 260 of the movement destination is increased by the added amount of the thumbnail 24a, the group 260 is enlarged and displayed as a group 261. In addition, in the drawing, since the thumbnail 24a is grouped into the group 261 of the movement destination, reference numeral 24a is changed to reference numeral 26c. As for the group 280, the group 280 is maintained as it is because there is no movement of the thumbnail.

In the lower portion of the common screen of FIG. 6, a button 300 for restoring to the state before the operation and a common screen 302 before the operation are displayed, and a button 304 for reflecting in the repository is displayed. The control device 16 holds the common screen (the screen illustrated in FIG. 4) before the thumbnail movement operation in the memory, and inserts the common screen before the movement operation into the common screen and displays the common screen when displaying the common screen after the movement operation illustrated FIG. 6. The user can easily confirm the common screen before the movement operation by visually recognizing the screen 302, and can redisplay the common screen before the movement operation by operating the button 300 as necessary. The change of the screen display by the operation of the buttons 300 and 304 will be further described later.

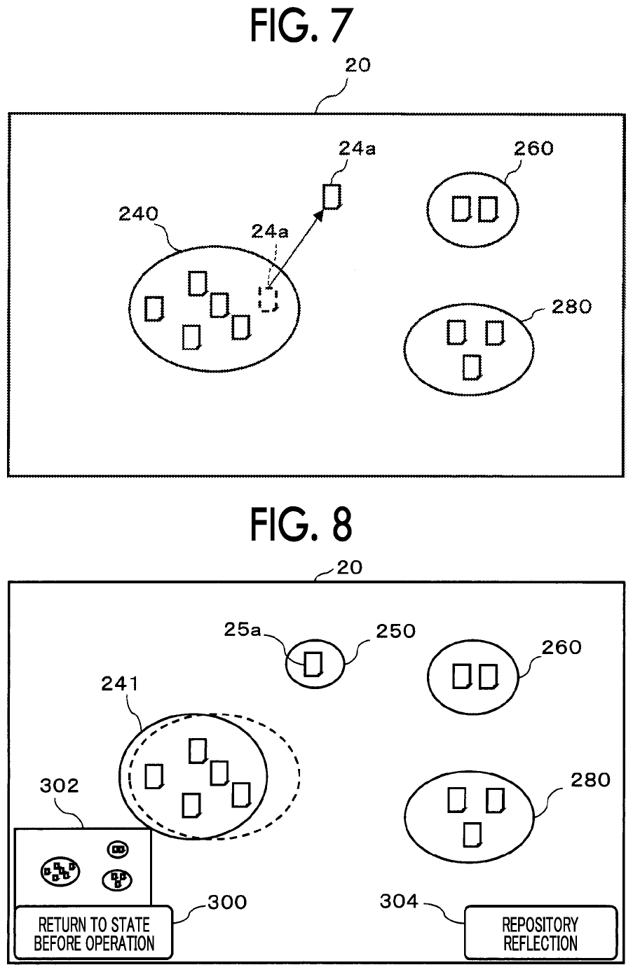

FIG. 7 illustrates how the thumbnail 24a is moved to a position other than the region where the groups 240, 260, and 280 exist. The control device 16 determines that there is no group at the coordinates of the movement destination of the thumbnail 24a, and newly creates a group at the coordinates of the movement destination.

FIG. 8 illustrates a redisplay screen of the group 240 which is the group of the movement source of the thumbnail 24a and the group of the movement destination of the thumbnails 24a. Since the number of thumbnails of the group 240 of the movement source is reduced by the amount of movement of the thumbnail 24a, the group 240 is reduced and displayed as a group 241. On the other hand, a new group 250 is generated at the movement destination of the thumbnail 24a. Since the new group 250 may include the thumbnail 24a, the size thereof may be smaller than that of the group 241, for example. Since the thumbnail 24a is grouped into the group 250 of the movement destination, reference numeral 25a is changed to reference numeral 24a. Since the group 250 is a newly added group, highlighting display or blinking display may be employed in order to emphasize the group 250.

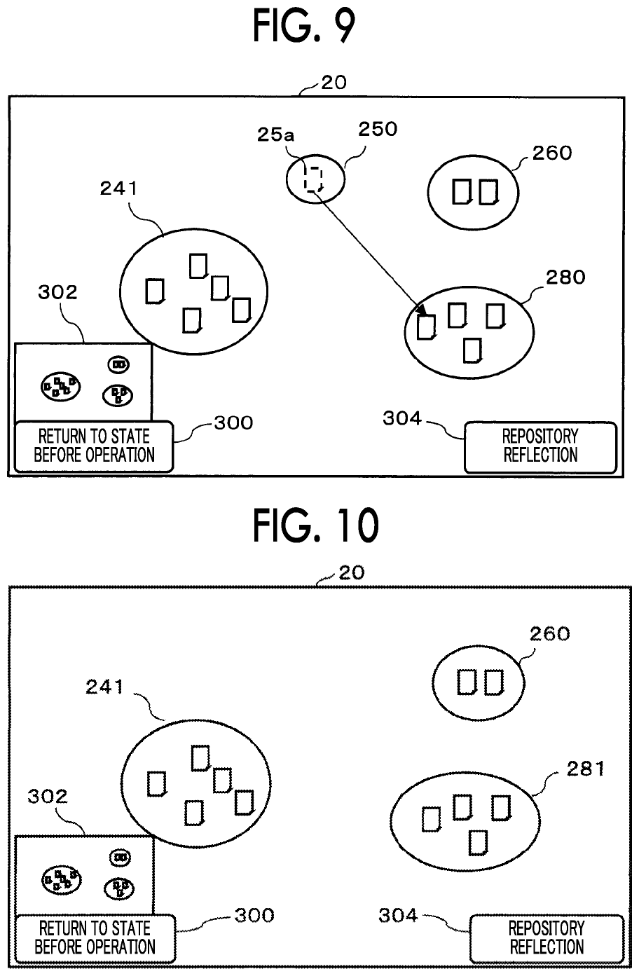

FIG. 9 illustrates a state where the user operates the input device 18 to further move the thumbnail 25a from the common screen display of FIG. 8. The user moves the thumbnail 25a from the group 250 to the group 280.

FIG. 10 illustrates a redisplay screen of the group 250 which is the group of the movement source of the thumbnail 25a and the group 280 of the movement destination of the thumbnail 25a. The group 250 of the movement source is deleted because the thumbnails no longer exist due to the movement of the thumbnail 25a. At this time, a state where the group 250 is deleted may be expressed by fade-out display. On the other hand, the group 280 which is the movement destination of the thumbnail 25a is enlarged and displayed in a group 281 because the number of thumbnails increases.

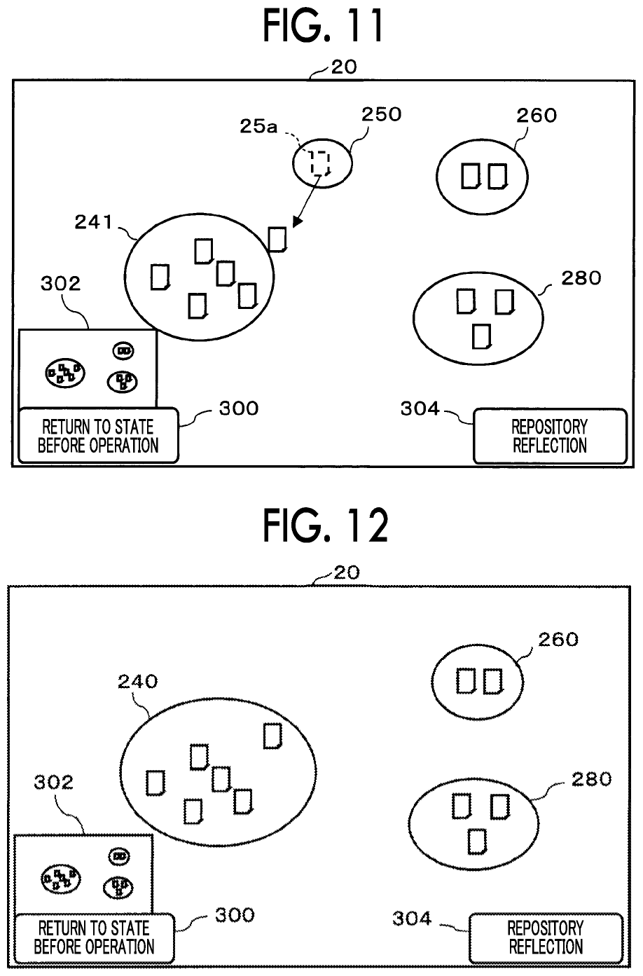

FIG. 11 illustrates a state where the user operates the input device 18 to further move the thumbnail 25a from the common screen display of FIG. 8. The user moves the thumbnail 25a from the group 250 to the vicinity of the group 241 which is a source group. Here, the term “vicinity” refers to “within a certain coordinate range from the group 241” and is set in advance as a processing program parameter.

FIG. 12 illustrates a redisplay screen of the group 250 which is the group of the movement source of the thumbnail 25a and the group 241 of the movement destination of the thumbnails 25a. When the control device 16 detects that the movement destination coordinates of the thumbnail 25a are in the vicinity of the group 241 of the source, the control device 16 regards this as the restoration operation to the group 241 of the source and returns the group 241 to the group 240 of the source. The group 240 of the source is a group including the thumbnail 25a, and the thumbnail 25a is restored to the thumbnail 24a. The group 250 of the movement source is deleted because the thumbnails no longer exist due to the movement of the thumbnail 25a. In other words, the group 250 is integrated into the group 241.

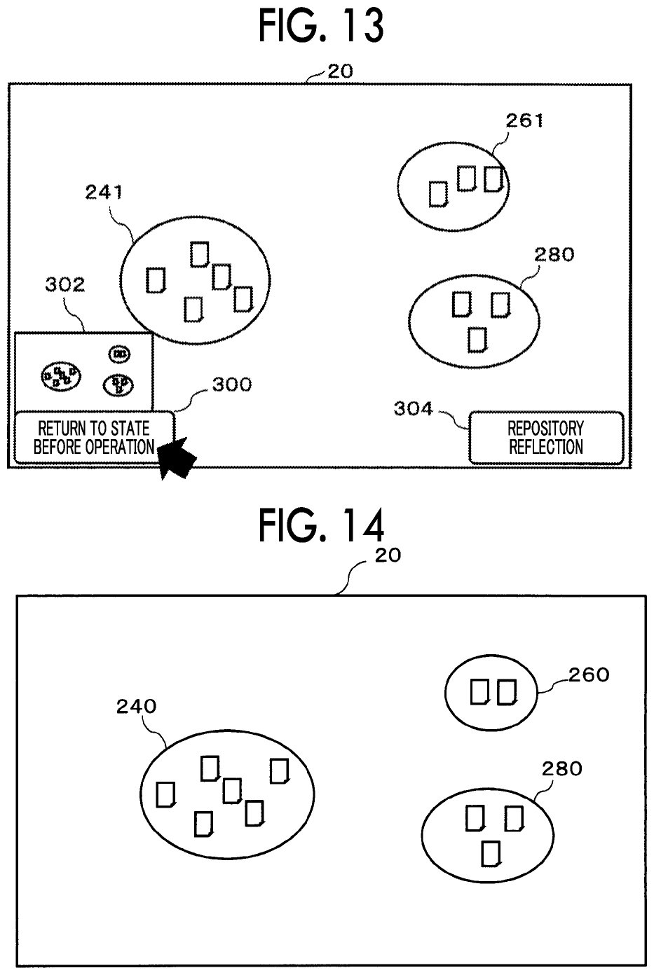

FIG. 13 illustrates how the user operates the input device 18 to operate the button 300 on the common screen illustrated in FIG. 6. In addition, the common screen of FIG. 6 is a screen in a case where the user moves the thumbnail 24a in the group 240 to the group 260.

FIG. 14 illustrates the common screen after the button 300 is operated. In response to the operation of the button 300, the control device 16 displays the common screen before the movement operation held in the memory. The screen is the same as the common screen of FIG. 5. In the related art, the “UNDO” function for restoring to the state before the operation is known. However, in the exemplary embodiment, the user can return to the common screen before the movement operation while confirming the common screen before the movement operation on the screen 302. In addition, in FIG. 14, the button 300, the screen 302, and the button 304 are not displayed. This is because it is not necessary to display the buttons 300 and 304 and the screen 302 anymore because the screen has returned to the common screen before the movement operation.

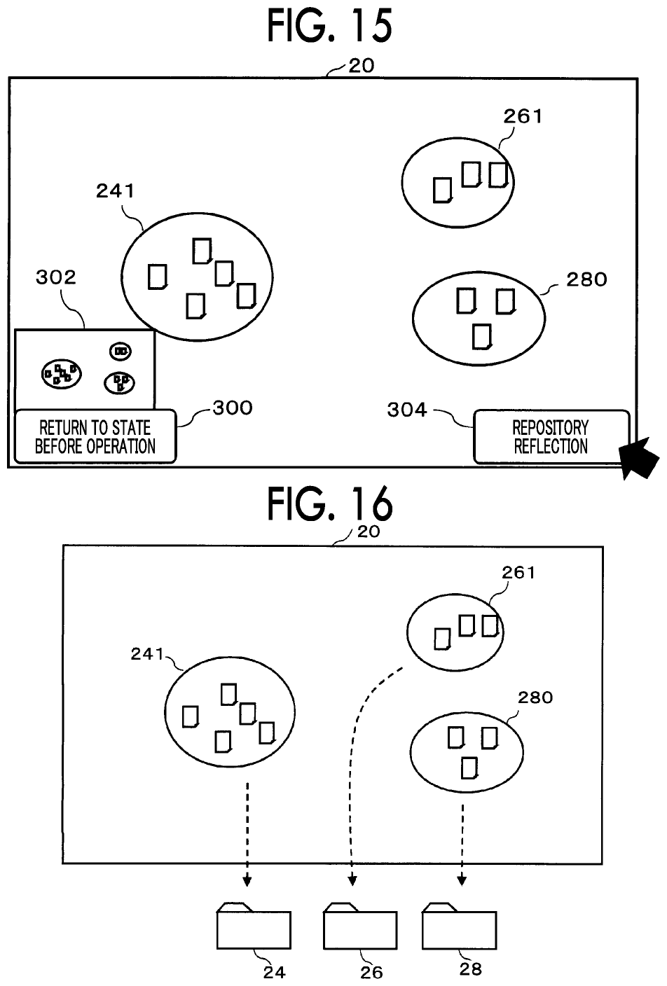

FIG. 15 illustrates how the user operates the input device 18 to operate the button 304 on the common screen illustrated in FIG. 6. The user instructs the completion of the movement operation, and operates the button 304 in a case of moving an actual file.

FIG. 16 schematically illustrates the process of the control device 16 in a case where the operation of the button 204 is received. The control device 16 moves the files stored in the folders 24, 26, and 28 in accordance with the thumbnail group grouped in the groups 241, 261, and 280. Since the group 241 corresponds to the folder 24 and the thumbnail 24a is moved, the file that corresponds to the thumbnail 24a is deleted from the folder 24. In addition, since the group 261 corresponds to the folder 26 and the thumbnail 24a is added and becomes the thumbnail 26c, the file that corresponds to the thumbnail 24a is added to the folder 26. Since the group 280 has not changed, the file in the folder 28 is maintained as it is.

The files stored in the folders 24, 26, and 28 before and after the repository reflection will be described in more detail.

In FIG. 15, on the common screen, since the thumbnails 24b to 24f are grouped into the group 241 and the thumbnails 26a to 26c are grouped into the group 261, the files that correspond to the thumbnails 24b to 24f appear to be stored in the folder 24 and the files that correspond to the thumbnails 26a to 26c appear to be stored in the folder 26, but in reality, the files that correspond to the thumbnails 24a to 24f are stored in the folder 24, and the files that correspond to the thumbnails 26a and 26b are stored in the folder 26. Therefore, the group of the common screen and the actual storage situation of the folders 24 and 26 do not match.

On the other hand, on the screen of FIG. 16, as a result of reflection of the group on the common screen in the repository, the files that correspond to the thumbnails 24b to 24f are stored in the folder 24 and the files that correspond to the thumbnails 26a to 26c are stored in the folder 26. Therefore, the group of the common screen and the actual storage situation of the folders 24, 26, and 28 match each other.

In addition, in a case where the reflection in a repository is completed, the control device 16 may display the message having the contents on the common screen. In addition, the display of the group before reflection in the repository and the display of the group after reflection in the repository may be changed. For example, the display color of the group before reflection in the repository and the display color of the group after reflection in the repository may be changed.

Although the exemplary embodiments of the present disclosure have been described above, the present disclosure is not limited to the exemplary embodiments, and various modifications are possible. The modification examples will be described hereinafter.

### MODIFICATION EXAMPLE 1

In the exemplary embodiment, in a case where there is a group at the coordinates of the movement destination of the thumbnail, the group is enlarged and redisplayed so as to include the thumbnail of the movement destination, but in a case where two files are combined as one file and have a bundling function, the function may be displayed on the common screen.

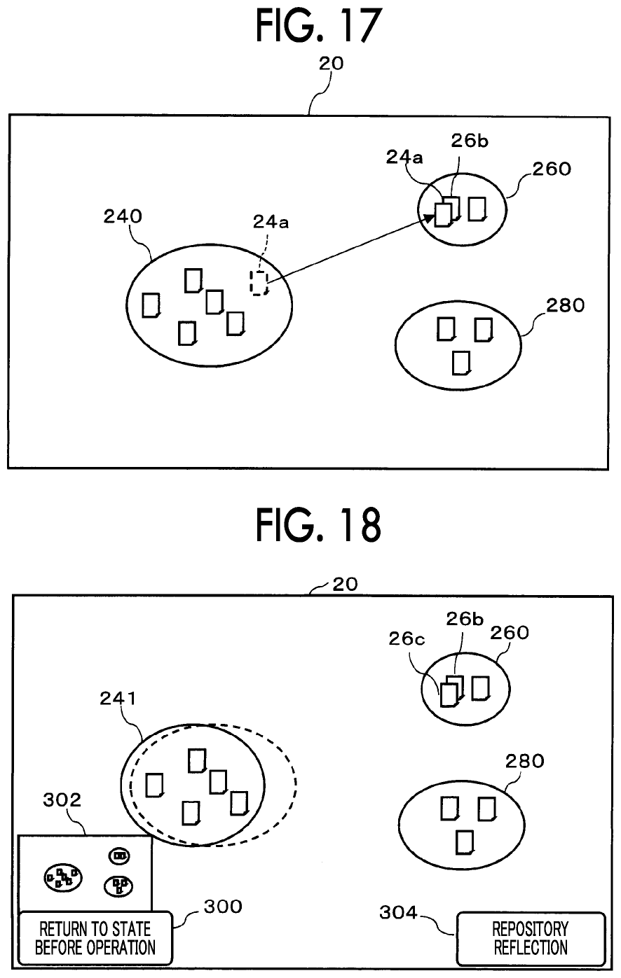

FIGS. 17 and 18 illustrate examples of the common screens in this case. FIG. 17 illustrates how the user has moved the thumbnail 24a to the position of the thumbnail 26b in the group 260 by moving the thumbnail 24a. In a case where the coordinates of the thumbnail 24a of the movement destination and the coordinates of the existing thumbnail 26b overlap each other, the control device 16 considers this as a bundling operation to combine the two files.

FIG. 18 illustrates the redisplay screen of the group 240 of the movement source and the group 260 of the movement destination. Since the number of thumbnails of the group 240 of the movement source is reduced by the amount of movement of the thumbnail 24a, the group 240 is reduced and displayed as a group 241. On the other hand, since the group 260 of the movement destination is a process of combining and bundling the files to which the thumbnail 24a is added, the thumbnail 24a is displayed superimposed on the thumbnail 26b as the thumbnail 26c, and the group 260 is not enlarged and displayed and maintains the same size as the group 260 of the source.

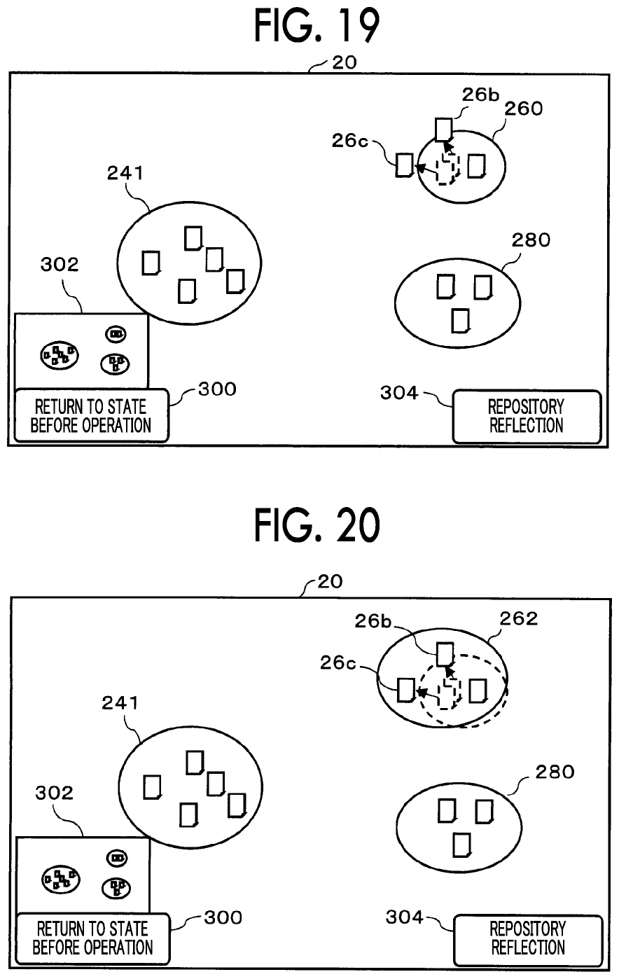

FIGS. 19 and 20 are operations reverse to those of FIGS. 17 and 18, and illustrate how to perform separating operation for separating two files combined (that is, bundled) into one file into two independent files of the source. When the user operates, for example, a menu to select separation of the files, the thumbnails displayed superimposed as illustrated in FIG. 19 are separated into the thumbnail 26b and thumbnail 26c.

FIG. 20 illustrates the redisplay screen of the group after the separation. Since the two thumbnails 26b and 26c are separated, the group 261 is enlarged and displayed in the group 262 so as to include the thumbnails 26b and 26c.

### MODIFICATION EXAMPLE 2

The exemplary embodiment exemplifies a case where the control device 16, the input device 18, the display device 20, and the storage device 22 are incorporated in one information processing apparatus as illustrated in FIG. 1, but may be implemented by a server client system that sends and receives data via a communication network. Specifically, plural user terminals and a shared server may be connected via a communication network, the control device 16 of the user terminal may access the storage device 22 of the shared server, and a common screen may be displayed on the display device 20 of the user terminal.

The foregoing description of the exemplary embodiments of the present disclosure has been provided for the purposes of illustration and description. It is not intended to be exhaustive or to limit the present disclosure to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

1. An information processing apparatus comprising:
a first display controller configured to perform control
to display plural pieces of data stored in plural storage regions in a memory on one common screen, and
to display a storage region display that shows the storage region in which each of the plural pieces of data is stored in the memory, on the common screen; and
a second display controller configured to perform control to change the storage region display on the common screen in accordance with an operation with respect to data displayed on the common screen.

2. The information processing apparatus according to claim 1, wherein the first display controller displays symbolic figures of the data on the common screen while maintaining a state where the data is stored in the storage regions.

3. The information processing apparatus according to claim 1, further comprising:
a controller configured to perform control to reflect the change in display due to the operation in the storage regions at a specific timing after completion of the operation.

4. The information processing apparatus according to claim 3, wherein the specific timing is a timing at which a user instructs the completion of the operation.

5. The information processing apparatus according to claim 1, wherein the storage region display differs in a display form for each storage region.

6. The information processing apparatus according to claim 1, wherein the storage region display is to group and display for each storage region.

7. The information processing apparatus according to claim 6, wherein the storage regions different from each other are displayed at different positions on the common screen as groups different from each other.

8. The information processing apparatus according to claim 1, wherein
the operation is movement of the data on the common screen, and
the second display controller changes the storage region display on the common screen in accordance with a position of the data after the movement.

9. The information processing apparatus according to claim 8, wherein
the storage region display is to group and display for each storage region, and
in a case where there is no grouped display at the position of the data after the movement, the second display controller displays a new group so that the new group includes the data to be moved.

10. The information processing apparatus according to claim 9, wherein in a case where the data to be moved is further moved to a vicinity of a group to which the data to be moved belongs before the movement after the new group is displayed, the second display controller integrates the new group into the group to which the data belongs before the movement.

11. The information processing apparatus according to claim 8, wherein
the storage region display is to group and display for each storage region, and
in a case where there is grouped display at the position of the data after the movement, the second display controller releases the group in which the data to be moved is grouped before the movement and displays the data to be moved as the same group as the group grouped at the position of the data after the movement.

12. The information processing apparatus according to claim 8, wherein
the storage region display is to group and display for each storage region, and
in a case where there is grouped display at the position of the data after the movement, the second display controller reduces and displays the group display grouped before the movement to be smaller than that before the movement, and enlarges and displays the group display grouped at the position of the data after the movement to be larger than that before the movement.

13. The information processing apparatus according to claim 8, wherein
the storage region display is to group and display for each storage region, and
in a case where there are other data at the position of the data after the movement, the second display controller bundles the data to be moved with the other data, and displays the data to be moved as the same group with the other data.

14. The information processing apparatus according to claim 1, wherein
the storage region display is to group and display for each storage region, and
in a case where bundled data is separated from each other by the operation, the second display controller separates the bundled data and displays the separated data as the same group.

15. The information processing apparatus according to claim 1, further comprising:
a third display controller configured to perform control to display the storage region display before the operation on the common screen.

16. The information processing apparatus according to claim 15, wherein the second display controller returns the storage region display on the common screen to the storage region display before the operation in accordance with a restoration operation.

17. A non-transitory computer readable medium storing a program that causes a computer to execute information processing, the information processing comprising:
performing control
to display plural pieces of data stored in plural storage regions in a memory on one common screen, and
to display a storage region display that shows the storage region in which each of the plural pieces of data is stored in the memory, on the common screen; and
performing control to change the storage region display on the common screen in accordance with an operation with respect to data displayed on the common screen.

18. An information processing apparatus comprising:
means for performing control
to display plural pieces of data stored in plural storage regions in a memory on one common screen, and
to display a storage region display that shows the storage region in which each of the plural pieces of data is stored in the memory, on the common screen; and
means for performing control to change the storage region display on the common screen in accordance with an operation with respect to data displayed on the common screen.
